(19) United States
(12) Patent Application Publication
(10) Pub. No.: US 2022/0080924 A1
(43) Pub. Date: Mar. 17, 2022

(54) Automobile Theft Prevention Device

(71) Applicant: Ion Gheorghe, Mississauga (CA)

(72) Inventor: Ion Gheorghe, Mississauga (CA)

(21) Appl. No.: 17/535,241

(22) Filed: Nov. 24, 2021

Related U.S. Application Data
(63) Continuation-in-part of application No. 16/795,500, filed on Feb. 19, 2020.

(51) Int. Cl. B60R 25/045; B60R 25/24; B60R 25/10; B60R 25/25; B60R 25/042

(52) U.S. Cl. CPC B60R 25/045; B60R 25/243; B60R 25/042; B60R 25/252; B60R 25/1003

(57) ABSTRACT

An article of manufacture for providing an automobile theft prevention device according to the present invention is disclosed.

### CROSS-REFERENCE TO RELATED APPLICATION

This application claims priority to U.S. patent application Ser. No. 16/795,500, titled “Automobile Theft Prevention Device,” and filed on Aug. 2, 2021. The entire application is incorporated herein by reference in its entirety.

### TECHNICAL FIELD

This application relates in general to an article of manufacture for providing an automobile theft prevention device.

### BACKGROUND

All the gas or diesel cars, except electrical cars, starts on the same principle. The driver, use a mechanical key, an electronic key with a chip embedded, or a fob with a transmitter embedded which permit to start the engine by turning the key, pressing a button, or by remote from a key fob.

The advance on RF technology today, permit to a lot of peoples to steal the data from the key and duplicate it. But the time for a thief to steal a car it is very limited, short, and under pressure if sometimes the alarm of the car start. By using a clone of your key or key fob, a thief can drive in no time out from a driveway, and even a satellite monitoring system associated with the car will not detect the theft as the car was legitimately started with a perfectly cloned key.

The present invention attempts to address the existing limitations in supporting an automobile theft prevention device according to the principles and example embodiments disclosed herein.

### SUMMARY

In accordance with the present invention, the above and other problems are solved by providing an article of manufacture for providing automobile theft prevention device.

In one embodiment, the present invention is an article of manufacture for providing an automobile theft prevention device. The device includes an input signal decoder for generating an enable code from an input from a driver, an interlocking device for determining whether the enable code received from the driver matches a predetermined code value. and an interlocking relay being activated by the interlocking device when the enable code matches the predetermined code value. The interlocking relay energizes a starter for an automobile engine permitting the engine to be started.

In another embodiment, the present invention is a method for securely starting an automobile. The method places a transponder near an antennae coupled to an RF receiver, receives an enable signal from the transponder, decodes the enable signal generating an enable code, and enables the automobile to start its engine when the enable code matches a predetermined code value.

The great utility of the invention is that the article of manufacture may provide an automobile theft prevention device a hidden and secure mechanism to start an automobile only when authorized by a proper driver. When a thief attempts to diagnose a problem with the starter, the engine will appear to be operating properly in spite of it not starting.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment an article of manufacture for automobile theft prevention device according to the present invention.

FIG. 2a-c illustrate schematic diagram for electronic circuitry corresponding to an article of manufacture for providing an automobile theft prevention device according to the present invention.

FIG. 3 illustrates a flowchart for a process to start an automobile using an interlocking device according to an example embodiment of the present invention.

FIG. 4 illustrates a flowchart for a process to start an automobile using an interlocking device according to an example embodiment of the present invention.

### DETAILED DESCRIPTION

This application relates in general an article of manufacture for providing an article of manufacturer for providing automobile theft prevention device.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “user” and “driver” refers to an entity, e.g. a human, that operates an automobile according to the present invention in order to bring about a desired effect or outcome, particularly provide the user an automobile theft prevention device according to the present invention. In a particular case, the user is one that is drives an automobile. For such a user, the terms “user” and “driver” may be used herein interchangeably.

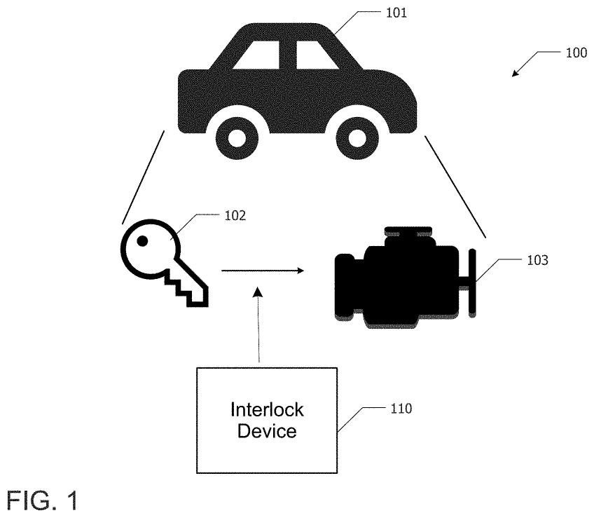

In general, the present disclosure relates general an article of manufacture for providing an automobile theft prevention device. To better understand the present invention, FIG. 1 represents one potential embodiment of general an article of manufacture for providing an automobile theft prevention device according to the present invention.

A quick look at the car starting diagram will show all of them more or less the same. On the car 101, an interlocking device 110 is installed along with an extra starter relay. When a driver starts an engine 103 in the car 101, the interlocking device 110 must be deactivated before a driver turns a key 102 in an effort to start the engine 103. If the interlocking device is not deactivated, the engine 103 will not start.

The interlocking device 110 may be hidden from view and the driver knows how to be deactivated. However, the interlocking device 110 is not readily visible or apparent to a thief. As such, the engine 103 will not start and the thief will not be able to drive the automobile 101 away.

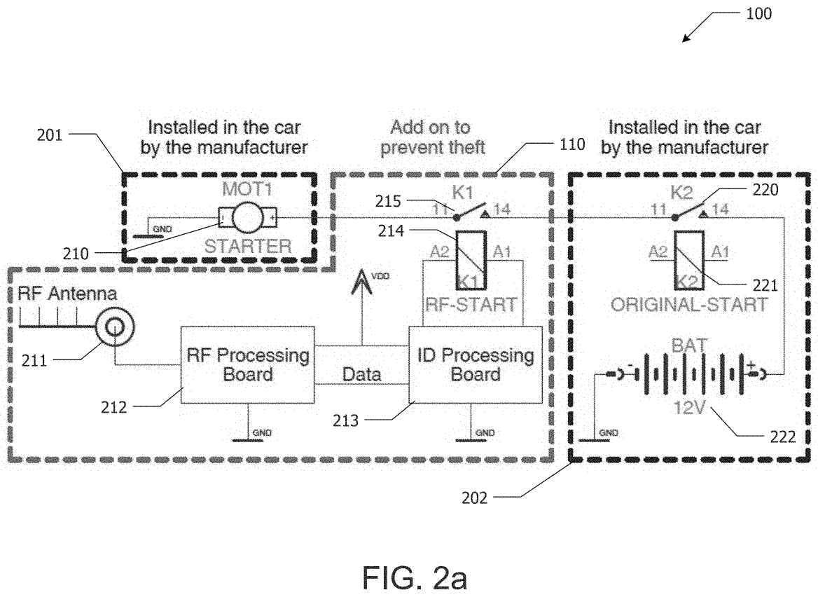

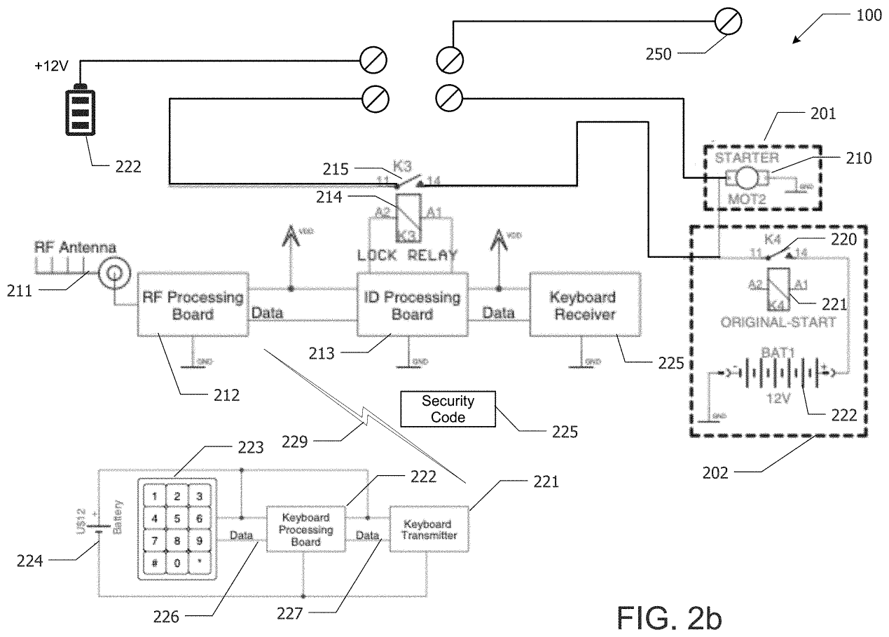

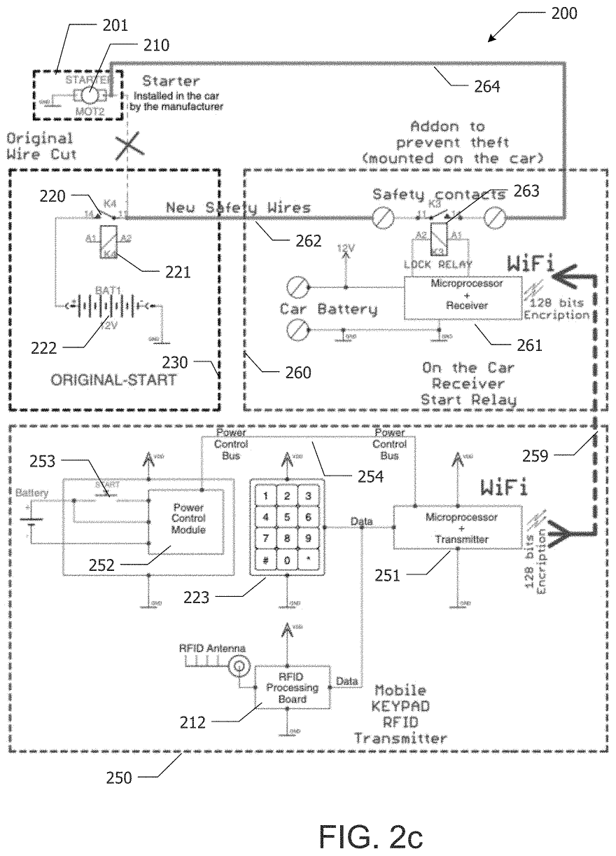

FIGS. 2a-c illustrate schematic diagrams for electronic circuitry corresponding to an article of manufacture for providing an automobile theft prevention device according to the present invention. FIG. 2a shows a first embodiment of the electronic circuity of an automobile theft prevention device.

A safety switch on the brake pedal, and electronic control board, a push button and a start relay which send voltage from the battery to the starter motor through a fuse. My idea is simple. Take the wire going to starter motor, just after the fuse, and pass it through a set of normal open contacts of the safety device 215. If the driver does not have the proper transponder, or does not know where is located the reception antenna, the starter motor will not start. The thief does not have the time to troubleshoot the issue. He can look at the fuse, which is OK, measure the voltage out from the starter relay which is OK, and conclude that the starter is defective. Just give up and move further to another car.

A wire from the original one 220, will go to the contact normal open of the second relay 215. Also inside of the car will be mounted a transponder antenna, connected to a transponder processing board.

To start the car, the driver first has to put to a distance not bigger than 20 cm. from the antenna, his personal transponder. From that moment, the ID of the transponder will be sent through a data cable to the processing board. The microprocessor on the interlocking device processing board, will compare the security code or ID of the transponder with the one stored on an electrically erasable programmable memory (EE-PROM) memory, and if they are the same, it will close the second starting relay for a duration of 5 minutes. Now, the driver can normally start his car like he did before. In one embodiment, the security code comprises a four byte code that may be views as a decimal number. For example, a four byte hexadecimal code $00 $90 $87 $F1 is equal to the decimal number 9,471,985. Any multi-byte code may be used as recited within the attached claims.

In another embodiment, the running of the engine may keep the interlocking device deactivated for a period of time, such as a few minutes, such that the engine may be easily restarted by a driver should the engine inadvertently stall without need to deactivate the interlocking device another time. Other embodiments may also use other mechanisms to deactivate the interlocking device using a keypad with a security code, a fingerprint reader containing fingerprint data associated with authorized drivers, a voiceprint decoder containing voice data associated with authorized drivers, a digital camera with face detection software using facial image data associated with authorized drivers, and similar authorizing technologies.

FIG. 2b shows a second embodiment of the electronic circuity of an automobile theft prevention device. The electronic circuity of an automobile theft prevention device in this embodiment operates in a similar manner as the circuitry described above with reference to FIG. 2a, except that instead of a transponder that contains a security code 225 of a transponder, a separate keyboard entry device 250 provides a keypad 223 for a driver to enter the security code 225 into the keyboard entry device 250. The keypad 223 is electrically coupled to a keyboard processing board 222 that generates the security code to be transmitted to the interlocking device 110. The keyboard processing board 222 decodes signals 226 received from the keypad 223 to determine which of the keypad 223 numbers have been depressed. Once decoded, a number associated with each keypad input is included within the security code 225.

Once a driver has entered a pre-defined number of digits, the security code 225 is transmitted by a keyboard transmitter 221 to the RF antennae 211 connected to the RF processing board 212. The keyboard transmitter 221 encodes the security code 225 into a sequence of RF signals 227 that may be transmitted. The RF processing board 212 decodes the received RF signals 227 to recover a transmitted security code corresponding to the security code generated by the keyboard processing board 222 as described above. The transmitted security code 229 is passed to the ID processing board 213 for matching with a previously stored security ID. When the transmitted security code is identical to the previously stored security ID, the lock relay 214 is closed allowing the switch 215 of the lock relay 214 enabling the starter to operate starting the automobile engine 103.

FIG. 2c shows yet another embodiment of the electronic circuity of an automobile theft prevention device. The system 200 comprises a mobile keypad RFID transmitter 250, an on-the-car receiver start relay 260, an original starter relay 230, and the engine starter 201. A user uses the mobile keypad RFID transmitter 250 to enter a security ID into a keypad 223 that is transmitted to the on-the-car receiver start relay 260 that enables a engine starter 201 to cause the internal combustion engine to run.

The mobile keypad RFID transmitter 250 is a device carried by the driver and comprises a power control module 252, the keypad 223, an RFID processing board 212, and a microprocessor and WiFi transmitter 251. The driver depresses an input button 253 causing the power control module 252 to activate a power control bus 254 that is connected to the microprocessor and WiFi transmitter 251. The microprocessor and WiFi transmitter 251 transmits an starter enable signal 259 via a WiFi connection to the on-the-car receiver start relay 260. The driver then enters the security ID into the keypad 223 that is received by the RFID processing board 212 that encodes the security ID for transmission to the microprocessor and WiFi transmitter 251 for inclusion in the WiFi data sent to the on-the-car receiver start relay 260.

The on-the-car receiver start relay 260 includes a microprocessor and WiFi receiver 261 that receives starter enable signal 259 containing the WiFi data sent from the mobile keypad RFID transmitter 250. The microprocessor and WiFi receiver 261 decodes the security ID within the WiFi data and compares it with a previously stored ID value, and when they match, the microprocessor and WiFi receiver 261 activates lock relay 263 to connect a new safety signal 262 from the ignition relay 220 to the engine starter 201 via the starter enable signal 264. When the driver activates the ignition relay 220, the car battery 222 is electrically connected engine starter 201 to cause the internal combustion engine to run.

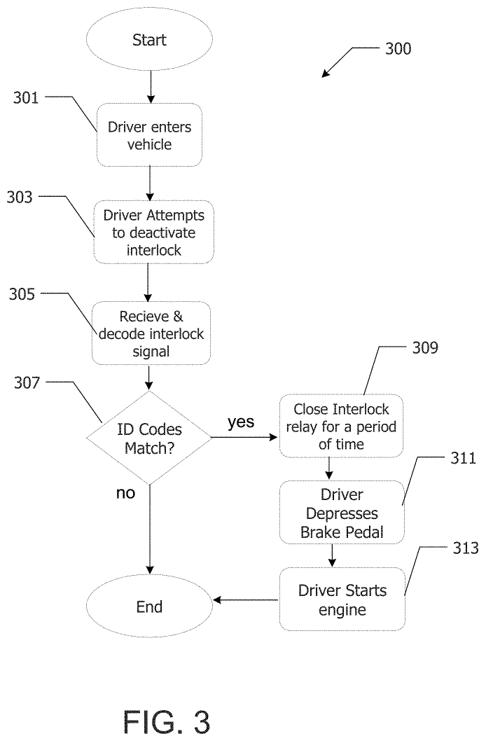

FIG. 3 illustrates a flowchart for a process to start an automobile 101 using an interlocking device according to an example embodiment of the present invention. The process of starting an automobile 101 by a driver getting into the automobile in step 301. The driver deactivates an interlocking device 110 by placing an RF unlocking device near an antennae of the interlocking device 110 and activating the RF circuit in step 303. The interlocking device 110 decodes an electronic signal received from the RF unlocking device in step 305 to decode an identification code within the electronic signal.

If the received identification code matches a pre-stored identification stored within the interlocking device 110, test step 307 permits the process to continue to deactivate the interlocking device 110 in step 309 by closing a relay between a key 102 or start button of the automobile and a starter circuit of the engine 103. If the received identification code does not match the pre-stored identification stored within the interlocking device 110, test step 307 ends the process.

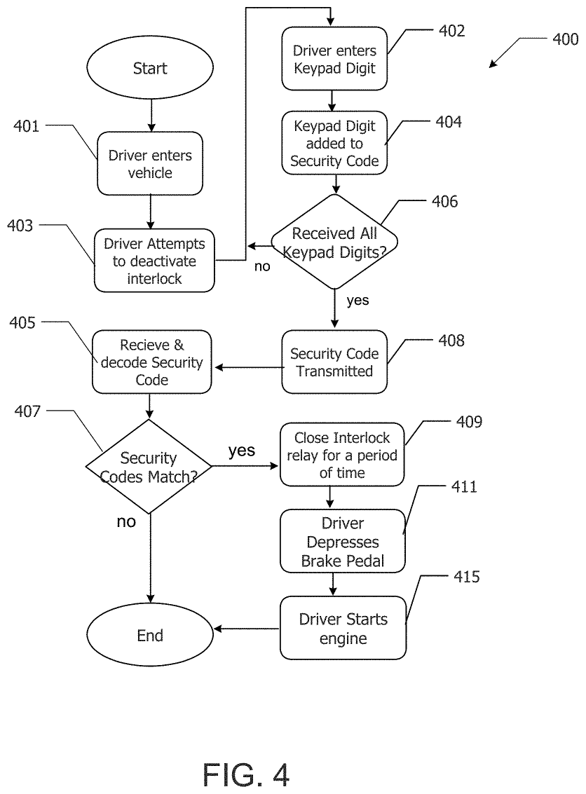

FIG. 4 illustrates a flowchart for a process to start an automobile 101 using an interlocking device according to an example embodiment of the present invention. The process of starting an automobile 101 by a driver getting into the automobile in step 401. The driver deactivates an interlocking device 110 by placing a keypad device near an antennae of the interlocking device 110 and being deactivating the interlocking device 220 in step 403.

A keypad entry is made on the keypad device 223 in step 402. The keypad device 223 send the keypad entry 226 to the keypad processing board 222 in step 404 that adds the keypad entry to the security code. Test step 406 determines if all of the digits of the security code 225 have been entered, and if not the process 400 returns to step 402 to receive the next keypad entry.

When test step 406 determines that all of the digits of the security code are received, the security code 225 is transmitted as a RF signal 229 to the RF antennae 211 for receipt by the RF processing board 212 in step 408. The interlocking device 110 decodes an electronic signal received from the RF unlocking device in step 405 to decode a transmitted security code within the electronic signal.

If the transmitted security code matches a pre-stored security code stored within the interlocking device 110, test step 407 permits the process to continue to deactivate the interlocking device 110 in step 409 by closing a relay between a key 102 or start button of the automobile and a starter circuit of the engine 103. If the received identification code does not match the pre-stored identification stored within the interlocking device 110, test step 407 ends the process.

The driver needs only place the transponder near the antenna location and enter the keypad digits. In a preferred embodiment a wider antennae may be used to provide a reading from the transponder up to 20 to 30 centimeters. Once a matching security code is received and decoded, the system is armed for 5 minutes. Then the driver try to start the car. If the engine does not start, the driver will again enter the keypad digits from a distance 20 to 30 cm. With a little practice he/she will find next time the good location to present the keypad.

Other embodiments may also use other mechanisms to deactivate the interlocking device using a keypad with a security code, a fingerprint reader containing fingerprint data associated with authorized drivers, a voiceprint decoder containing voice data associated with authorized drivers, a digital camera with face detection software using facial image data associated with authorized drivers, and similar authorizing technologies.

Once the interlocking device 110 is deactivated, the safety relay is activated in step 309 and the starter in energized in step 311. The driver depresses the brake pedal of the automobile 101 to close a safety circuit in step 313 and the engine starts in step 315 with the driver turns the key 102 or depresses the start button.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A device for providing an automobile theft prevention device, the device comprises:
an input signal decoder for generating an enable code from an input from a driver;
an interlocking device for determining whether the enable code received from the driver matches a predetermined code value; and
an interlocking relay being activated by the interlocking device when the enable code matches the predetermined code value;
wherein the interlocking relay energizes a starter for an automobile engine permitting the engine to be started.

2. The device according to claim 1, wherein the device further comprises:
an RF receiver for receiving an enable signal from a transponder; and
wherein the input signal decoder processes a signal received from the RF receiver to generates the enable code; and
the driver causes the RF receiver to receive the enable signal when the transponder is held close to an antennae coupled to the RF receiver.

3. The device according to claim 2, wherein the enable code comprises a multi-byte hexadecimal digit code.

4. The device according to claim 4, wherein multi-byte hexadecimal digit code requires at least four byte codes.

5. The device according to claim 2, wherein the RF receiver recognizes the enable signal when the transponder is within 20-30 centimeters from the antennae.

6. The device according to claim 1, wherein the input received from the driver is generated by a keypad.

7. The device according to claim 1, wherein the input received from the driver is generated by a fingerprint reader.

8. A method for securely starting an automobile, the method comprising:
placing a transponder near an antennae coupled to an RF receiver;
receiving an enable signal from the transponder;
decoding the enable signal generating an enable code; and
enabling the automobile to start its engine when the enable code matches a predetermined code value.

9. The method according to claim 8, wherein the enabling the automobile engine comprising:
activating an interlocking relay when the enable code matches the predetermined code value; and
energizing a starter when the interlocking relay is activated.

10. The method according to claim 8, wherein the enable code comprises a four digit code.

11. The method according to claim 8, wherein the RF receiver recognizes the enable signal when the transponder is within 20-30 centimeters from the antennae.

12. The method according to claim 8, wherein the enable code received from the driver is generated by a keypad.

13. The method according to claim 8, wherein the enable code received from the driver is generated by a fingerprint reader.

14. The method according to claim 8, wherein the enable code comprises a multi-byte hexadecimal digit code.

15. The device according to claim 14, wherein multi-byte hexadecimal digit code requires at least four byte codes.
